(19) United States
(12) Patent Application Publication
(10) Pub. No.: US 2010/0316282 A1
(43) Pub. Date: Dec. 16, 2010

(54) Derivation of 3D information from single camera and movement sensors

(76) Inventor: Clinton B. Hope, Los Angeles, CA (US)

Correspondence Address: INTEL CORPORATION;c/o CPA Global, P.O. BOX 52050, MINNEAPOLIS, MN, 55402, US

(21) Appl. No.: 12/653,870

(22) Filed: Dec. 18, 2009

Related U.S. Application Data
(60) Provisional application No. 61/187,520, filed on Jun. 16, 2009.

(51) Int. Cl. G06K 9/00

(52) U.S. Cl. 382/154

(57) ABSTRACT

In various embodiments, a camera takes pictures of at least one object from two different camera locations. Measurement devices coupled to the camera measure the change in location and the change in direction of the camera from one location to the other, and derive 3-dimensional information on the object from that information and, in some embodiments, from the images in the pictures.

### CROSS-REFERENCE TO RELATED APPLICATIONS

This application is derived from U.S. provisional patent application Ser. No. 61/187,520, filed Jun. 16, 2009, and claims priority to that filing date for all applicable subject matter.

### BACKGROUND

As the technology of handheld electronic devices improves, various types of functionality are being combined into a single device, and the form factor of these devices is becoming smaller. These devices may have extensive processing power, virtual keyboards, wireless connectivity for cell phone and interne service, and cameras, among other things. Cameras in particular have become popular additions, but the cameras included in these devices are typically limited to low resolution snapshots and short video sequences. The small size, small weight, and portability requirements of these devices prevents many of the more sophisticated uses for cameras from being included. For example, 3D photography can be enabled by taking two pictures of the same object from physically separated locations, thus giving a slightly different visual perspective of the same scene. Techniques for such stereo imaging algorithms typically require accurate knowledge of the relative geometry of the two positions from which the two pictures are taken. In particular, the distance separating the two camera positions and the convergence angle of the optical axes are essential information in extracting depth information from the images. Conventional techniques typically require two cameras taking simultaneous pictures from rigidly fixed positions with respect to each other, which can require a costly and cumbersome setup. This approach is impractical for small and relatively inexpensive handheld devices.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a multi-function handheld user device with a built-in camera, according to an embodiment of the invention.

FIGS. 2A and 2B show a framework for referencing linear and angular motion, according to an embodiment of the invention.

FIG. 3 shows a camera taking two pictures of the same objects at different times from different locations, according to an embodiment of the invention.

FIG. 4 shows an image depicting an object in an off-center position, according to an embodiment of the invention.

FIG. 5 shows a flow diagram of a method of providing 3D information for an object using a single camera, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a computer-readable medium, which may be read and executed by one or more processors to enable performance of the operations described herein. A computer-readable medium may include any mechanism for storing information in a form readable by one or more computers. For example, a computer-readable medium may include a tangible storage medium, such as but not limited to read only memory (ROM); random access memory (RAM); magnetic disk storage media; optical storage media; a flash memory device, etc.

Various embodiments of the invention enable a single camera to derive three dimensional (3D) information for one or more objects by taking two pictures of the same general scene from different locations at different times, moving the camera to a different location between pictures. Linear motion sensors may be used to determine how far the camera has moved between pictures, thus providing a baseline for the separation distance. Angular motion sensors may be used to determine the change in direction of the camera, thus providing the needed convergence angle. While such position and angular information may not be as accurate as what is possible with two rigidly mounted cameras, the accuracy may be sufficient for many applications, and the reduction in cost and size over that more cumbersome approach can be substantial.

Motion sensors may be available in various forms. For example, three linear motion accelerometers, at orthogonal angles to each other, may provide acceleration information in three dimensional space, which may be converted to linear motion information in three dimensional space, and that in turn may be converted to positional information in three dimensional space. Similarly, angular motion accelerometers may provide rotational acceleration information about three orthogonal axes, which can be converted into a change in angular direction in three dimensional space. Accelerometers with reasonable accuracy may be made fairly inexpensively and in compact form factors, especially if they only have to provide measurements over short periods of time.

Information derived from the two pictures may be used in various ways, such as but not limited to:

1) Camera-to-object distance for one or more objects in the scene may be determined.

2) The camera-to-object distance for multiple objects may be used to derive a layered description the relative distances of the objects from the camera and/or from each other.

3) By taking a series of pictures of the surrounding area, a 3D map of the entire area may be constructed automatically. Depending on the long-term accuracy of the linear and angular measurement devices, this might enable a map of a geographically large area to be produced simply by moving through the area and taking pictures, provided each picture has at least one object in common with at least one other picture, so that the appropriate triangulation calculations may be made.

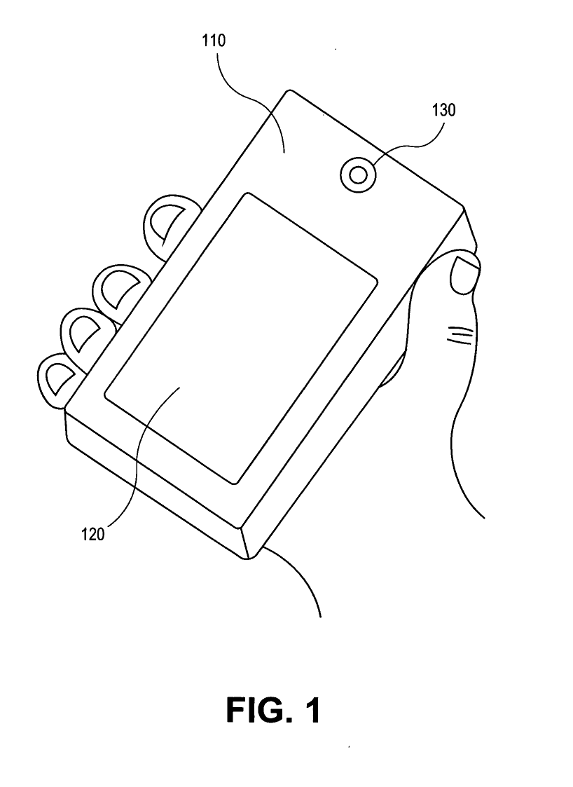

FIG. 1 shows a multi-function handheld user device with a built-in camera, according to an embodiment of the invention. Device 110 is shown with a display 120 and a camera lens 130. The rest of the camera, as well as a processor, memory, radio, and other hardware and software functionality, may be contained within the device and is not visible in this figure. The devices for determining motion and direction, including mechanical components, circuitry, and software, may be external to the actual camera, though physically and electronically coupled to the camera. Although the illustrated device 110 is depicted as having a particular shape, proportion, and appearance, this is for example only and the embodiments of the invention may not be limited to this particular physical configuration. In some embodiments, device 110 may be primarily a camera device, without much additional functionality. In some embodiments, device 110 may be a multi-function device, with many other functions unrelated to the camera. For ease of illustration, the display 120 and camera lens 130 are shown on the same side of the device, but in many embodiments the lens will be on the opposite side of the device from the display, so that the display can perform as a view finder for the user.

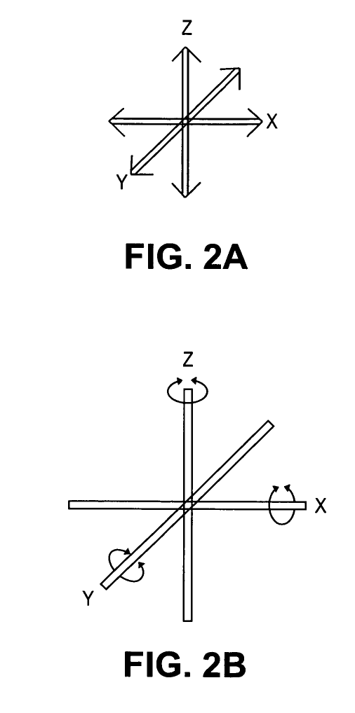

FIGS. 2A and 2B show a framework for referencing linear and angular motion, according to an embodiment of the invention. Assuming three mutually perpendicular axes X, Y, and Z, FIG. 2A shows how linear motion may be described as a linear vector along each axis, while FIG. 2B shows how angular motion may be described as a rotation about each axis. Taken together, these six degrees of motion may describe any positional or rotational motion of an object, such as a camera, in three dimensional space. However, the XYZ framework with respect to the camera may change when compared to an XYZ framework for the surrounding area. For example, if motion sensors such as accelerometers are rigidly mounted to the camera, the XYZ axes that provide a reference for these sensors will be from the reference point of the camera, and the XYZ axes will rotate as the camera rotates. But if the motion information that is needed is the motion with respect to a fixed reference external to the camera, such as the earth, the changing internal XYZ reference may need to be converted to the comparatively immovable external XYZ reference. Fortunately, algorithms for such a conversion are known, and will not be described here in any further detail.

One technique for measuring motion is to use accelerometers coupled to the camera in a fixed orientation with respect to the camera. Three linear accelerometers, each with its measurement axis in parallel with a different one of the three axes X, Y, and Z, can detect linear acceleration in the three dimensions, as the camera is moved from one location to another. Assuming the initial velocity and position of the camera is known (such as starting from a standstill at a known location), the acceleration detected by the accelerometers can be used to calculate velocity along each axis, which can in turn be used to calculate a change in location at a given point in time. Because the force of gravity may be detected as acceleration in the vertical direction, this may be subtracted out of the calculations. If the camera is not in a level position during a measurement, the X and/or Y accelerometer may detect a component of gravity, and this may also be subtracted out of the calculations.

Similarly, three angular accelerometers, each with its rotational axis in parallel with the three axes X, Y, and Z, can be used to detect rotational acceleration of the camera in three dimensions (i.e., the camera can be rotated to point in any direction), independently of the linear motion. This can be converted to angular velocity and then angular position.

Because a slight error in measuring acceleration may result in a continuously increasing error in velocity and position, periodic calibration of the accelerometers may be necessary. For example, if the camera is assumed to be stationary when the first picture is taken, the accelerometer readings at that point in time may be assumed to represent a stationary camera, and only changes from those readings will be interpreted as an indication of motion.

Other techniques may be used to detect movement. For example, a global positioning system (GPS) may be used to locate the camera at any given time, with respect to earth coordinates, and location information for different pictures may therefore be determined directly. An electronic compass may be used to determine the direction in which the camera is pointed at any given time, also with respect to earth coordinates, and the directional information of the optical axis for different pictures may be determined directly from the compass. In some embodiments, the user may be required to level the camera to the best of his/her ability when taking pictures (for example, a bubble level or an indication from an electronic tilt sensor may be provided on the camera), to reduce the number of linear sensors down to two (X and Y horizontal sensors) and reduce the number of directional sensors down to one (around the vertical Z axis). If an electronic tilt sensor is used, it may provide leveling information to the camera to prevent a picture from being taken if the camera is not level, or provide correction information to compensate for a non-level camera when the picture is taken. In some embodiments, positional and/or directional information may be entered into the camera from external sources, such as by the user or by a local locator system that determines this information by methods outside the scope of this document, and wirelessly transmits that information to the camera's motion detection system. In some embodiments, visual indicators may be provided to assist the user in rotating the camera in the right direction. For example, an indicator in the view screen (e.g., arrow, circle, skewed box, etc.) may show the user which direction to rotate the camera (left/right and/or up/down) to visually acquire the desired object in the second picture. In some embodiments, combinations of these various techniques may be used (e.g., GPS coordinates for linear movement and angular accelerometer for rotational movement). In some embodiments, the camera may have multiple ones of these techniques available to it, and the user or the camera may select from the available techniques and/or may combine multiple techniques in various ways, either automatically or through manual selection.

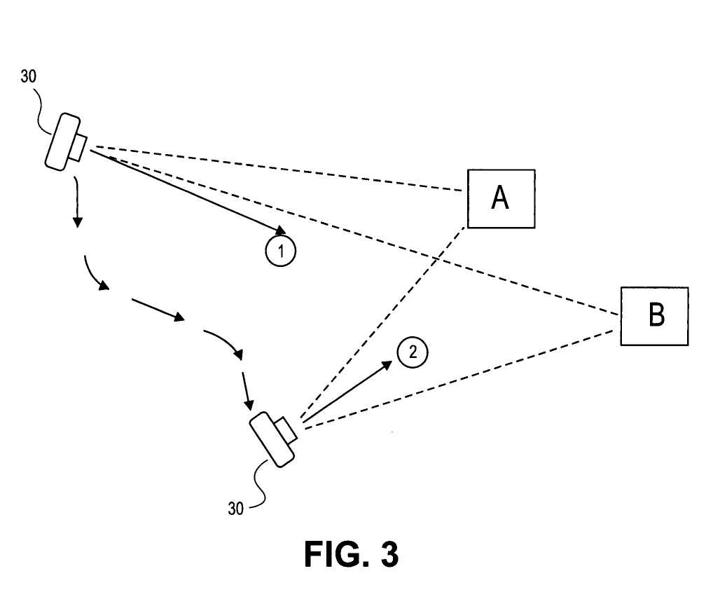

FIG. 3 shows a camera taking two pictures of the same objects at different times from different locations, according to an embodiment of the invention. In the illustrated example, camera 30 takes a first picture of objects A and B, with the optical axis of the camera (i.e., the direction the camera is pointing, equivalent to the center of the picture) pointing in the direction 1. The direction of objects A and B with respect to this optical axis are shown with dashed lines. After moving the camera 30 to the second location, the camera 30 takes a second picture of objects A and B, with the optical axis of the camera pointed in direction 2. As indicated in the figure, the camera may be moved between the first and second locations in a somewhat indirect path. It is the actual first and second locations that are important in the ultimate calculations, not the path followed between them, but in some embodiments a complicated path may complicate the process of determining the second location.

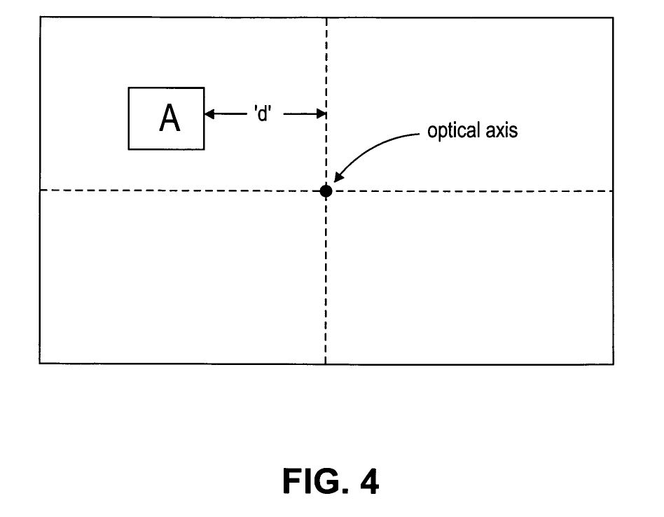

As can be seen, in this example neither of the objects is directly in the center of either picture, but the direction of each object from the camera may be calculated, based on the camera's optical axis and where the object appears in the picture with respect to that optical axis. FIG. 4 shows an image depicting an object in an off-center position, according to an embodiment of the invention. The optical axis of the camera will be in the center of the image of any picture taken, as indicated in FIG. 4. If object A is located off-center in the image, the horizontal difference ‘d’ between the optical axis and that object's position in the image may be easily converted to an angular difference from the optical axis, which should be the same regardless of the object's physical distance from the camera. The dimension ‘d’ shows a horizontal difference, but if needed, a vertical difference may also be determined in a similar manner.

Thus, the direction of each object from each camera location may be calculated, by taking the direction the camera is pointing and adjusting that direction based on the placement of the object in the picture. It is assumed in this description that the camera uses the same field of view for both pictures (e.g., no zooming between the first and second pictures) so that an identical position in the images of both pictures will provide the same angular difference. If different fields of view are used, it may be necessary to use different conversion values to calculate the angular difference for each picture. But if the object is aligned with the optical axis in both pictures, no off-center calculations may be necessary. In such cases, an optical zoom between the first and second pictures may be acceptable, since the optical axis will be the same regardless of the field of view.

Various embodiments may also have other features, instead of or in addition to the features described elsewhere in this document. For example, in some embodiments, the camera may not enable a picture to be taken unless the camera is level and/or steady. In some embodiments, the camera may automatically take the second picture once the user moves the camera to a nearby second location and the camera is level and steady. In some embodiments, several different pictures may be taken at each location, each one centered on a different object, before moving to the second location and taking object-centered pictures of the same objects. Each pair of pictures of the same object may be treated in the same manner as described for two pictures.

Based on the change of location and the change of direction from the camera to each object, various 3D information may be calculated for each of objects A and B. In the illustration, the second camera position is closer to the objects than the first position, and that difference may also be calculated. In some embodiments, if an object appears to be a different size in one picture than another, the relative sizes may help to calculate the distance information, or at least relative distance information. Other geometric relationships may also be calculated, based on the available information.

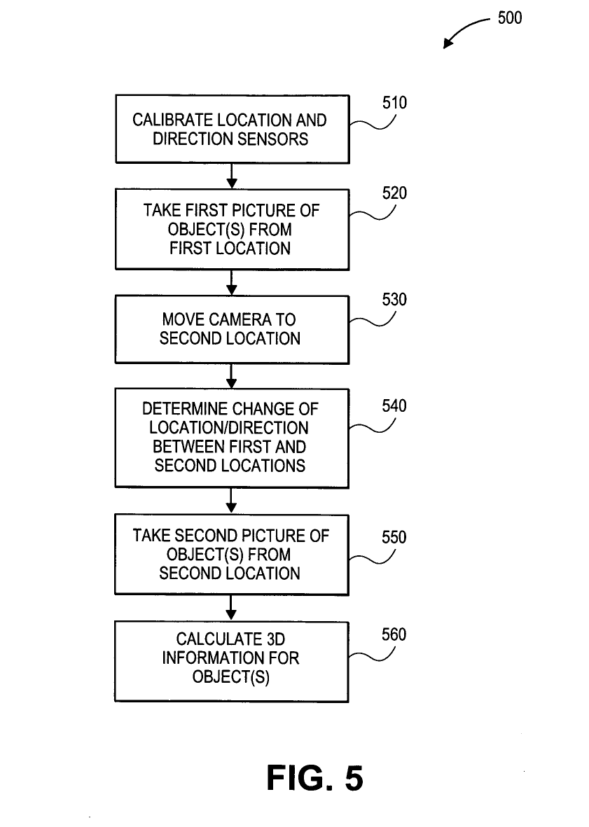

FIG. 5 shows a flow diagram of a method of providing 3D information for an object using a single camera, according to an embodiment of the invention. In flow diagram 500, in some embodiments the process may begin at 510 by calibrating the location and direction sensors, if required. If the motion sensing is performed by accelerometers, a zero velocity reading may need to be established for the first position, either just before, just after, or at the same time, as the first picture is taken at 520. If there is nothing to calibrate, operation 510 may be skipped and the process started by taking the first picture at 520. Then at 530 the camera may be moved to the second position, where the second picture is to be taken. Depending on the type of sensors used, at 540 the linear and/or rotational movement may be monitored and calculated during the move (e.g., for accelerometers), or the second position/direction may simply be determined at the time the second picture is taken (e.g., for GPS and/or compass readings). At 550 the second picture is taken. Based on the change in location information and the change in directional information, various types of 3D information may be calculated at 560, and this information may be put to various uses.

The foregoing description is intended to be illustrative and not limiting. Variations will occur to those of skill in the art. Those variations are intended to be included in the various embodiments of the invention, which are limited only by the scope of the following claims.

What is claimed is:

1. An apparatus, comprising:
a camera for taking a first picture of an object from a first location at a first time and for taking a second picture of the object from a second location at a second time;
a motion measurement device coupled to the camera, the motion measurement device to determine changes in angular direction of the camera for the first and second pictures and changes in linear position of the camera between the first and second locations; and
a processing device to determine three dimensional information about the object with relation to the camera, based on the changes in the angular direction and the changes in the linear position.

2. The apparatus of claim 1, wherein the motion measurement device comprises linear accelerometers.

3. The apparatus of claim 1, wherein the motion measurement device comprises at least one angular accelerometer.

4. The apparatus of claim 1, wherein the motion measurement device comprises a global positioning system to determine linear distance between the first and second locations.

5. The apparatus of claim 1, wherein the motion measurement device comprises a directional compass to determine a change in the angular direction of the camera between the first and second pictures.

6. A method, comprising:
taking a first picture of an object with a camera from a first location at a first time;
moving the camera from the first location to a second location;
taking a second picture of the object with the camera from the second location at a second time; and
determining, by electronic devices coupled to the camera, a linear distance between the first and second locations and an angular change in an optical axis of the camera between the first and second times.

7. The method of claim 6, further comprising determining a location of the object relative to the first and second locations, based on the linear distance and the angular change.

8. The method of claim 6, wherein said determining comprises:
measuring acceleration along multiple perpendicular axes to determine the linear distance; and
measuring angular acceleration around at least one rotational axes to determine the angular change.

9. The method of claim 6, wherein said determining comprises leveling the camera a first time before taking the first picture and leveling the camera a second time before taking the second picture.

10. The method of claim 6, wherein said determining an angular change comprises determining an angular direction of the object for the first picture based partly on a position of the object in the first picture, and determining an angular direction of the object for the second picture based partly on a position of the object in the second picture.

11. The method of claim 6, wherein said determining the linear distance comprises using a global positioning system to determine the first and second locations.

12. The method of claim 6, wherein said determining the angular change comprises using a compass to determine the direction for the optical axis at the first time and at the second time.

13. An article comprising
a computer-readable storage medium that contains instructions, which when executed by one or more processors result in performing operations comprising:
determining a first location and a first direction of an optical axis of a camera for taking a first picture of an object;
determining a second location and a second direction of the optical axis of the camera for taking a second picture of the object; and
determining a linear distance between the first and second locations and an angular change in the optical axis between the first and second locations.

14. The article of claim 13, further comprising the operation of determining a location of the object relative to the first and second locations based on the linear distance and the angular change.

15. The article of claim 13, wherein the operation of determining the linear distance comprises measuring acceleration along multiple perpendicular axes.

16. The article of claim 13, wherein the operation of determining the linear distance comprises determining the first and second locations with a GPS system.

17. The article of claim 13, wherein the operation of determining the angular change in the optical axis comprises measuring angular acceleration around at least one rotational axis.

18. The article of claim 13, wherein the operation of determining the angular change comprises determining an angular direction of the object for the first picture based on a position of the object in the first picture, and determining an angular direction of the object for the second picture based on a position of the object in the second picture.

19. The article of claim 13, wherein the operation of determining the linear distance comprises using a global positioning system to determine the first and second locations.

20. The article of claim 13, wherein the operation of determining the angular change comprises using an electronic compass to determine a direction for the optical axis for the first picture and for the second picture.
